(19) United States
(12) Patent Application Publication
(10) Pub. No.: US 2026/0159757 A1
(43) Pub. Date: Jun. 11, 2026

(54) Method for Enhancing Soil Properties Using Nano-Additives or Pico-Additives in Deep Soil Mixing (Nano-DSM or Pico-DSM)

(71) Applicants: Hamed NIROUMAND, Tehran (IR); Lech Balachowski, Gdansk (PL)

(72) Inventors: Hamed NIROUMAND, Tehran (IR); Lech Balachowski, Gdansk (PL)

(21) Appl. No.: 18/974,809

(22) Filed: Dec. 10, 2024

(51) Int. Cl. C09K 17/10; C09K 17/44

(52) U.S. Cl. CPC C09K 17/10; C09K 17/44

(57) ABSTRACT

A method for enhancing soil properties in order to obtain an enhanced soil using a first mixture comprising a cement nano-additives and/or pico-additives and water in deep soil mixing is realized by an equipment for performing the method according to this invention. The nano-additives or pico-additives are selected from the group including a nano-fly ash, a nano-rice husk, a nano-cement, a nano-bentonite, a nano-clay, a nano-illite, and a nano-kaolinite. The nano-additives or pico-additives are ground to nano or pico sizes using preferably a ball mill. The optimal mix ratio of water-to-the nano-additives or pico-additives ranges from 1:4 to 4:1 wt./wt.

### BACKGROUND OF THE INVENTION

### Field of the Invention

The present invention relates to a method for improving the properties of soil using nano-additives or smaller additives such as pico-additives in deep soil mixing (Nano-DSM). This method involves the preparation of various nano-additives including nano-fly ash, nano-rice husk, nano-cement, nano-bentonite, nano-clay, nano-illite, nano-kaolinite, nano-silica, and all types of nano-scale of additives or nano-bio additives optimal mix design, and the application of the enhanced slurry into the soil using specific equipment. This technique significantly enhances the strength, durability, and overall performance of the soil, making it suitable for various geotechnical applications.

### Brief Description of the Background of the Invention Including Prior Art

Traditional soil stabilization methods often use additives such as lime and cement.

Article by Masaki Kitazume (Department of Civil and Environmental Engineering, Tokyo Institute of Technology, Tokyo 152-8550, Japan; published: 1 Oct. 2021) discloses the deep mixing method (DMM), an in situ soil stabilization technique, was developed in Japan and Nordic countries in the 1970s and has gained increased popularity in many countries. The quality of stabilized soil depends upon many factors, including its type and condition, the type and amount of binder, and the production process. Quality control and quality assurance (QC/QA) practices focus on stabilized soil, and comprises laboratory mix tests, field trial tests, monitoring and controlling construction parameters, and verification. QC/QA is one of the major concerns for clients and engineers who have less experience with the relevant technologies. In this manuscript, the importance of QC/QA-related activities along the workflow of deep mixing projects is emphasized based on the Japanese experience/results with mechanical mixing technology by vertical shaft mixing tools with horizontal rotating circular mixing blade. The current and recent developments of QC/QA are also presented. However, this method does not disclose use of the nano-additives for the soil stabilization.

Document U.S. Pat. No. 6,457,905B1 discloses an improved deep remediation injection system for in-situ remediation of contaminated soil and ground water. The system includes a soil penetrating lance for injecting at least two different highly-pressurized fluids taken from the group of air, gaseous oxygen, ozone, oxygenated liquid, hydrogen peroxide, surfactant-containing liquid, catalyst-containing liquid and suspended biologicals-containing liquids, or a liquid containing other chemicals, into said contaminated soil as said soil penetrating lance is inserted for penetration therein.

Document JP3665307B2 discloses soil improvement method for chemically contaminated zone and mixing device used therefor. This method is used in order to purify the area contaminated by organic compounds such as trichlorethylene with Raney nickel and hydrogen.

Document U.S. Pat. No. 10,787,865B2 discloses an in-situ injection of soil and groundwater high pressure rotary jet grouting in-situ remediation system and method. The system has an agent dispensing station, high pressure grouting pump, air compressor, rotary jet grouting drilling machine, second double-pipe water flow joint, automatic lifting mechanism for grouting drill pipe of rotary jet grouting drilling machine, high pressure jet drill pipe, inner tube for high pressure jet triple drill pipe, outer tube for high pressure jet triple drill pipe, agent jet nozzle, an air jet nozzle, cemented carbide block and a drill bit.

### Technical Problem

Prior art solutions solve some of the problems involved in the soil stabilizing. However, they do not disclose any use of nano-particles or nano-additives for those methods. The introduction of nano-additives can provide superior improvements in soil properties. This invention aims to leverage the benefits of nano-additives to enhance the effectiveness of deep soil mixing techniques. Traditional additives are generally referred to simply as additives. In this application, changing the size of particles from macro to micro, nano, and pico represents a new approach for the future of additives. The importance of altering particle sizes has been demonstrated to improve the properties of soils through the use of nano and pico additives.

### SUMMARY OF THE INVENTION

### Purposes of the Invention

It is an object of the present invention to provide a method for enhancing soil properties in order to obtain an enhanced soil or stabilized soil, wherein the required physical and mechanical properties of the enhanced soil can be obtained easier and cheaper as compared to the methods of soil stabilization known from the prior art.

In particular, it is an object of this invention to improve the soil strength, reduce the hydraulic conductivity, and enhance the compressibility of the soil on the construction site in the required places.

### BRIEF DESCRIPTION OF THE INVENTION

The present invention relates to a method for enhancing soil properties in order to obtain an enhanced soil using a first mixture comprising cement, nano-additives and/or pico-additives and water in deep soil mixing. The method is comprising the following steps:
Step A—obtaining a soil sample from a construction site,
Step B—identifying and testing physical and mechanical properties of the soil sample. Using nano-additives in deep soil mixing can significantly enhance the physical and mechanical properties of the soil. Nano-additives such as nano-silica, nano-clay, and nano-illite are known to improve soil strength, reduce hydraulic conductivity, and enhance compressibility.
Step C—determining required amount and recommended mixing composition of the first mixture with the soil by using predetermined tests data and/or test results from Step F. Preferably, the amount of nano or pico additives such as cement, lime, kaolonite, bentonite, illite, etc. is 1-10% in the composition. The required water content and all properties are based on existing applications on the specific construction site,
Step D—preparing and mixing the required amount of the nano-additives and/or pico-additives, cement and water in order to obtain the first mixture,
Step E—mixing the prepared amount of the first mixture with the soil by using a mixer, preferably single auger or multi-auger or jet-grouting or paddle mixers, in order to obtain a second mixture,
Step F—performing the test on the obtained second mixture and if the properties of the second mixture are as required, performing the Steps H-N, if not, performing Steps C-F again, taking into consideration the test results of Step F and adjusting the required amounts of water, cement and nano material to be mixed in Step D,
Step G—cancelling the results of the previous Steps D and E, and going back to Step C again,
Step H—deep drilling in the predetermined places of the ground or soil on the construction site. Wording “deep drilling” in this application means that the depth of the drilling is in the range 0.1-60 m, preferably 1-40 m, more preferably 2-20 m, still more preferably 3-10 m, most preferably 4-8 m.
Step I—applying or pumping the second mixture or the enhanced second mixture, wherein the second mixture or the enhanced second mixture is an enhanced slurry, into the drilled soil in the predetermined places on the construction site using a device for supplying the enhanced slurry into the drilled soil,
Step J—mixing the soil with the enhanced slurry by using a deep soil mixing machine in order to obtain a third mixture. Deep soil mixing is known in geotechnical engineering and building industry and therefore doesn't need to be described in details in this application,
Step K—injecting nano stabilizer to the third mixture. In deep soil mixing, stabilizers are injected into the soil using specialized equipment and methods to enhance its physical and mechanical properties. The primary means include the rotary method, where a machine with rotating shafts or blades pumps the stabilizer in slurry form through a nozzle, mixing it with the soil. Jet grouting uses high-pressure jets to inject the stabilizer, creating soil-cement columns and improving soil properties at greater depths. Wet mixing involves injecting stabilizing agents in slurry form through a feeding pipe connected to the mixing tool, ensuring thorough mixing to the targeted depth. Dry mixing, on the other hand, uses mechanical tools to inject and mix dry stabilizing agents with the soil, suitable for conditions where adding water is not feasible. These methods ensure even distribution of the stabilizer, leading to improved soil stability and strength.
Step L—mixing the third mixture with the nano stabilizer in the drilled soil in order to obtain a forth mixture. In deep soil mixing, the process of combining the soil with the enhanced slurry and stabilizer within the drilled soil is achieved using specialized equipment. Rotary mixing involves machines with rotating shafts or blades that pump the stabilizer slurry through a nozzle, thoroughly blending it with the soil. Jet grouting employs high-pressure jets to inject the slurry, ensuring uniform mixing and creating robust soil-cement columns. Wet mixing uses a feeding pipe connected to a mixing tool to inject and mix the slurry with the soil to the desired depth. Dry mixing, suitable for conditions where adding water is not feasible, involves mechanical tools that inject and mix dry stabilizing agents with the soil. These methods ensure the stabilizer is evenly distributed, enhancing the soil's stability and strength.
Step M—curing the forth mixture in order to obtain the enhanced soil. Generally, the curing period ranges from 7 to 28 days, preferably 8 to 25 days, most preferably 10 to 20 days. 92 days are considered necessary for ground improvement control.
Step N—continuously controlling, automatically and/or manually, depending on the project's needs, the amount of moisture in the enhanced soil, and if necessary adjusting the amount of moisture by adding required amount of water in order to obtain the desired performance criteria of the enhanced soil.

### Preparation of the Nano-Additives or Pico-Additives:

Nano-Rice Husk: Rice husk is processed to extract nano-silica particles, which are then uniformly distributed. Nano-Fly Ash: Fly ash is ground to nano size using a ball mill or similar equipment, ensuring uniform particle size distribution. Nano-Cement: Ordinary Portland cement is ground to nano size, ensuring uniform particle size distribution. Nano-Bentonite: Bentonite is processed to nano size, enhancing its ability to improve soil properties. Nano-Clay: Clay is ground to nano size, ensuring fine dispersion between soil particles. Nano-Illite: Illite is processed to nano size, forming nano-cementation that enhances soil durability. Nano-Kaolinite: Kaolinite is ground to nano size, improving the mechanical properties of weak soils. In this description, wherever the word “nano” or “nano-size” is used, it also includes “pico” or “pico-size”. Nano is the size equal to 10-9 m and pico is the size equal to 10-12 m. Nano-sized particles of any component described in this description means that at least 90% of the three dimensional particles have the average size of at least one dimension equal or below 100 nm. Pico-sized particles of any component described in this description means that at least 90% of the three dimensional particles have the average size of at least one dimension equal or below 100 μm.

### Mix Design:

Optimal Ratios: Laboratory tests determine the optimal mix ratio of soil and various nano-additives. Typical starting ratios are 1-10% of nano additives by weight of the soil. Water Content: The water-to-cement ratio is adjusted to achieve the desired consistency and workability of the mix, typically ranging from 20% to 80% of water, preferably 30% to 70% of water, most preferably 40% to 60% of water.

### Mixing Process:

Dry Mixing: The soil is initially mixed with the nano-additives in dry form to ensure even distribution. In deep soil mixing, the soil is initially mixed with nano-additives in dry form using specialized equipment to ensure even distribution. This process typically involves the use of drilling rigs equipped with mixing tools such as auger cutting heads, discontinuous auger flights, and mixing paddles. Additionally, horizontal axis rotating mixing tools, often mounted on the end of a track hoe arm, are used to inject and mix the dry binder with the soil. Stationary or mobile binder storage and feeding plants provide a consistent supply of the dry binder to the mixing tools. These methods and equipment ensure that the nano-additives are evenly distributed throughout the soil, enhancing its properties for effective ground improvement. Wet Mixing: Water is added to the dry mix and blended thoroughly. The water content is optimized based on the soil type and desired properties (according to soil properties in different layers). This process is typically carried out using specialized equipment such as horizontal axis rotary mixing tools mounted on the end of a track hoe arm.

### Deep Soil Mixing:

Equipment: Deep soil mixing equipment such as augers or mixing blades is used.

Injection: The nano-enhanced slurry is injected into the soil at the required depth (1-60 m).

The enhanced slurry is pumped through the hollow stem of the mixing shaft and injected at the tip. The volumetric flow rate for injecting the enhanced slurry typically ranges from 0.08 to 1 m³/min, depending on the soil type and equipment capacity.

### Compaction:

The third mixture or fourth mixture is compacted to enhance its density and strength. In the context of deep soil mixing, compaction equipment refers to the machinery used to blend and compact soil with binders like cement to improve its density and strength. This equipment typically includes mixing shafts with auger cutting heads, revolving hollow shafts with mixing paddles, and cutter wheels. These tools ensure thorough mixing and compaction, enhancing the soil's properties for construction or stabilization projects.

### Curing Period:

The fourth mixture or treated soil is allowed to cure for a specified period, typically ranging from a few days to several weeks in order to obtain the enhanced soil.

### Moisture Control:

Adequate moisture levels are maintained during curing of the treated soil to ensure proper hydration and strength development. In deep soil mixing, maintaining adequate moisture levels during curing is crucial for proper hydration and strength development. This can be achieved by sealing and storing samples in a moist environment, regularly spraying water on the treated soil, covering the soil with moisture-retaining materials like plastic sheets, and applying membrane-forming compounds to reduce moisture loss. These methods ensure the soil remains adequately hydrated, leading to improved strength and stability.

### Quality Control and Testing:

Field Testing: Field tests such as unconfined compressive strength (UCS) tests and direct shear tests are conducted to evaluate the enhanced soil properties. Monitoring: The enhanced soil is continuously monitored to ensure it meets the desired performance criteria.

### Final Assessment:

Performance Evaluation: The overall performance of the enhanced soil is assessed, including its strength, stiffness, and durability. In deep soil mixing, the performance evaluation of enhanced soil involves assessing its strength, stiffness, and durability. Strength is typically measured in kilopascals (kPa) or megapascals (MPa) using the Unconfined Compressive Strength (UCS) test. Stiffness is measured in newtons per meter (N/m) or kilonewtons per meter (kN/m) through tests like the modulus of elasticity. Durability is evaluated based on the soil's resistance to environmental conditions such as wetting and drying cycles, freeze-thaw cycles, and chemical attack, using various durability tests. These assessments ensure the soil meets necessary performance standards for construction and stabilization projects.

Adjustments: Necessary adjustments to the enhanced soil or process are made based on the test results and performance evaluation. In deep soil mixing, necessary adjustments refer to changes made to the soil treatment process or the composition of the enhanced soil based on performance evaluations. If test results indicate that the soil's strength, stiffness, or durability are insufficient, adjustments might include modifying the binder mix, altering mixing techniques, adjusting moisture content, or re-evaluating curing methods. These adjustments ensure the enhanced soil meets the required standards for stability and performance in construction projects.

### The Key Innovative Aspects:

This invention integrates advanced nano-materials and/or pico-materials (powder or suspension) into traditional deep soil mixing techniques, resulting in significantly enhanced soil stabilization and improvement. The key innovative aspects include: the use of nano-materials (as Nano-Geotechnics (NaG), Nano Soil Improvement (NSI), Nano Ground Improvement (NGI), Nano Soil Stabilization (NSS), Pico Soil Stabilization (PSS), Pico Soil Improvement (PSI), Pico Ground Improvement (PGI)) such as all types of nano-scale of additives such as cement, fly-ash, lime, clay types (illite, bentonite, kaolinite, monmoriolinite and etc.), silica and chemical solutions improves the mechanical properties of the soil, including increased strength, reduced permeability, and enhanced durability.

### Environmental Benefits:

Nano-materials and/or pico-materials reduce the need for large quantities of traditional stabilizing agents like cement and lime, thereby minimizing the environmental impact and carbon footprint associated with soil stabilization.

### Improved Efficiency:

The incorporation of nano-materials and/or pico-materials allows for faster and more efficient soil mixing processes, reducing project timelines and costs.

### Versatility:

This method can be applied to a wide range of soil types and conditions, making it a versatile solution for various geotechnical challenges.

### Innovative Application:

The integration of nano-technology and/or pico-technology in deep soil mixing is a novel approach that has not been previously explored, offering a unique solution to soil stabilization problems. In this invention, soil can be mixed with additives and water, or geopolymers can be used, resulting in a process called Nano DSM with Geopolymer.

### Main Features of the Invention:

A geopolymer binder is added and mixed with the soil, which provides an environmentally friendly alternative to traditional cementitious binders, offering improved durability and reduced carbon footprint. Mixing Process: A method for thoroughly mixing the soil with the nano-materials and/or pico-materials and water or geopolymer binder, provides uniform distribution and integration throughout the treated soil mass. Water Addition: Controlled addition of water to activate the geopolymer binder and facilitate the mixing process, ensuring optimal consistency and workability of the soil mixture. Soil Stabilization: The resulting mixture must demonstrate enhanced soil stabilization properties, including increased strength, reduced permeability, and improved resistance to environmental factors. Application Versatility: The process is applicable to a wide range of soil types and conditions, making it suitable for various geotechnical challenges. Environmental Benefits: The use of nano-materials and/or pico-materials with water or geopolymers should contribute to environmental sustainability by reducing the need for traditional cement and lime, thereby lowering the overall carbon footprint.

Preferably, the nano-additives or pico-additives are selected from the group including nano-fly ash, nano-rice husk, nano-cement, nano-bentonite, nano-clay, nano-illite, and nano-kaolinite.

Preferably, the nano-additives or pico-additives are ground to nano or pico sizes using a ball mill including a plurality of metal or composite balls. Ball milling preferred due to its access and simple production process, higher nanoparticle production speed, cost-effectiveness, and implementation. Treating the additives is performed by grinding and/or crushing and/or shredding the batch additives in a rotating ball mill, wherein the ball mill includes a plurality of mill balls, wherein the average particle size of at least 50% of the modified additives powder produced is between 2 nm and 150 nm, preferably between 2 nm and 100 nm. The names “nano-additives” used in this description means a component which average particles size as measured using a DLS or SEM method is below 150 nm, preferably below 100 nm. The names “pico-additives” used in this description means a component which average particles size as measured using a DLS or SEM method is below 150 μm, preferably below 100 μm. Ball mills are well known from the prior art therefore the construction of the ball mill will be not described in more details.

Preferably, the amount of the components of the first mixture are selected from the following ranges:
Nano Cement: 5-7%
Nano Fly Ash: 10-15%
Nano Illite: 2-4%
Nano Bentonite: 3-5%
Water: 20-30%

More preferably, the amount of the components of the first mixture are selected from the following ranges:
Nano Cement: 6-8%
Nano Fly Ash: 12-18%
Nano Illite: 3-5%
Nano Bentonite: 4-6%
Water: 25-35%

Still more preferably, the amount of the components of the first mixture are selected from the following ranges:
Nano Cement: 7-9%
Nano Fly Ash: 14-20%
Nano Illite: 4-6%
Nano Bentonite: 5-7%
Water: 30-40%

Still more preferably, the amount of the components of the first mixture are selected from the following ranges:
Nano Cement: 8-10%
Nano Fly Ash: 16-22%
Nano Illite: 5-7%
Nano Bentonite: 6-8%
Water: 35-45%

Most preferably, the amount of the components of the first mixture are selected from the following ranges:
Nano Cement: 9-11%
Nano Fly Ash: 18-24%
Nano Illite: 6-8%
Nano Bentonite: 7-9%
Water: 40-50%

Preferably, the optimal mix ratio of water-to-the nano-additives or pico-additives ranges from 1:4 to 4:1 wt./wt.

Preferably, the volumetric flow rate for applying or injecting the enhanced slurry into the soil ranges from 0.08 to 1 m³/min, more preferably from 0.1 to 0.8 m³/min, still more preferably from 0.2 to 0.6 m³/min, most preferably from 0.4 to 0.5 m³/min.

Preferably, the method further comprising the step of compacting the enhanced soil by using a compaction equipment to enhance its density and strength of the enhanced soil. In the context of deep soil mixing, the compaction equipment refers to the machinery used to blend and compact soil with binders like cement to improve its density and strength. This equipment typically includes mixing shafts with auger cutting heads, revolving hollow shafts with mixing paddles, and cutter wheels. These tools ensure thorough mixing and compaction, enhancing the soil's properties for construction or stabilization projects.

### BRIEF DESCRIPTION OF THE DRAWINGS

These aims together with other objects and advantages which will become subsequently apparent reside in the details of the construction and operation as more fully hereinafter described and claimed, reference being made to the accompanying drawings forming a part hereof, wherein the same numerals refer to the same parts throughout.

In drawings

FIG. 1 illustrates schematically a construction site with a complete equipment used to perform the method according to this invention,

FIG. 2 illustrates schematically a cross section of a part of the construction site with parts of the equipment used to drill and mix the soil with the additives,

FIG. 3 illustrates schematically a cross section of cement storage tank,

FIG. 4 illustrates schematically a cross section of powder or solution tank,

FIG. 5 illustrates a flowchart of the process.

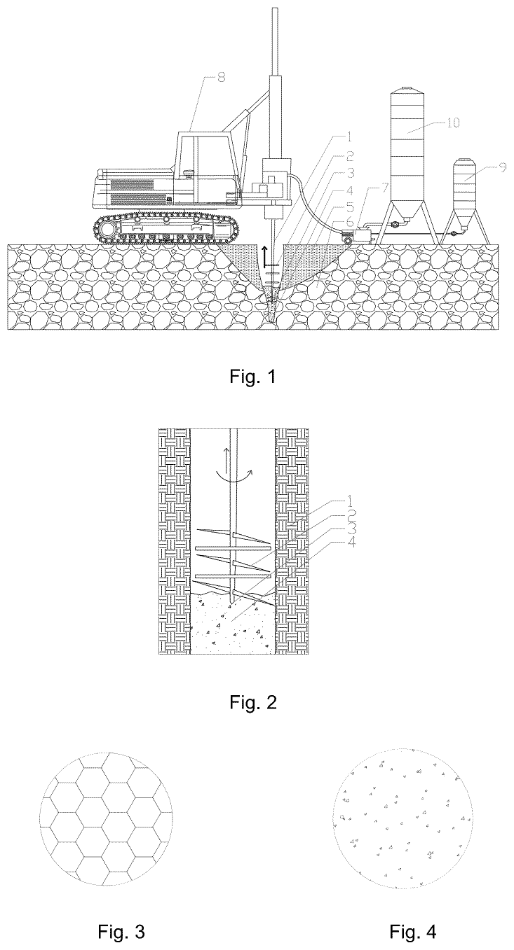

### DETAILED DESCRIPTION OF INVENTION AND PREFERRED EMBODIMENT

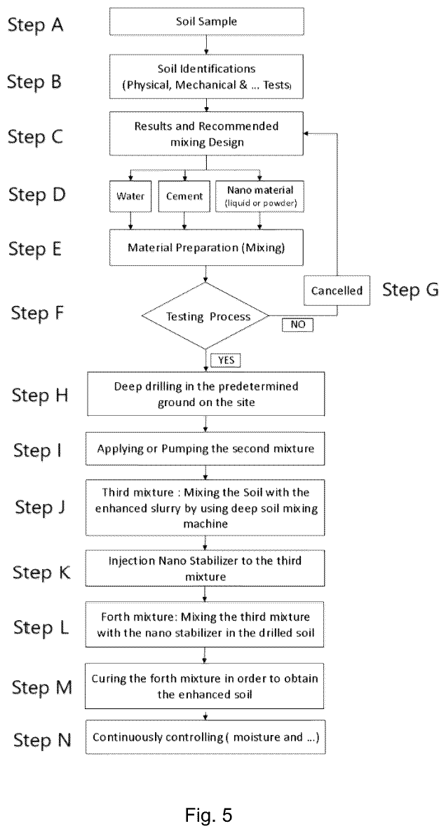

Referring to the drawing, FIG. 1 shows schematically a construction site with a complete equipment used to perform the method according to this invention. Combining this description with the description of FIG. 5: An operator of a drilling machine 8 positions an outer rod 1 together with a mixing blade 2 and a mixing head 3 over the surface of the soil in the place intended to be drilled. The outer rod 1 is lowered and the mixing head 3 together with the mixing blade starts rotating and inserting into the soil. After reaching predetermined depth the outer rod 1 is retracted and a sample of the soil is obtained (Step A). In the nest step (Step B) the soil sample is examined by the operator and the physical and mechanical properties of the soil sample are identified. In Step C required amount and recommended mixing composition of the soil with the cement, the nano-additives and/or the pico-additives and water, being the second mixture, is determined by using data obtained in previous tests.

Applications: the method according to this invention is used for forming columns or walls at various depths to improve subgrade and base course.

### Nano Deep Soil Mixing (NDSM).

Nano deep soil mixing incorporates nanomaterials to enhance the properties of the soil-binder mixture. Nanomaterials, such as nano-cement, significantly improve the strength and stiffness of the soil by forming calcium silicate hydrate (C-S-H) gel that fills the pores and bonds the soil particles.

### Key Components and Techniques:

Nanomaterials: Nano-cement is a common additive, with optimal content found to be around 2-10% by weight.
Performance: Nano-cement can increase the unconfined compressive strength of the soil by up to 29 times and reduce strain at rupture by 74% compared to untreated soil.
Mechanism: Nano-cement acts as a nucleation site for more C-S-H growth, enhancing the durability and strength of the mixture.

In Step D the required amount of the nano-additives or pico-additives are prepared, preferably in separate ball mill, and loaded into the powder or solution tank 9. This invention has been realized and tested for the following specific percentage amounts of the ingredients of the enhanced slurry and other parameters:

### Example No. 1

Nano Cement: 5%
Nano Fly Ash: 10%
Nano Illite: 2%
Nano Bentonite: 3%
Water: 20%
Soil: 60%
Volumetric Flow Rate: 0.5 m³/min
Nano Stabilizer: Nano-silica
Curing Time: 7 days
Mix Ratio (Water-to-Nano Additives):3:1

### Example No. 2

Nano Cement: 6%
Nano Fly Ash: 12%
Nano Illite: 3%
Nano Bentonite: 4%
Water: 25%
Soil: 50%
Volumetric Flow Rate: 1.0 m³/min
Nano Stabilizer: Nano-fly ash
Curing Time: 14 days
Mix Ratio (Water-to-Nano Additives):4:1

### Example No. 3

Nano Cement: 7%
Nano Fly Ash: 14%
Nano Illite: 4%
Nano Bentonite: 5%
Water: 30%
Soil: 40%
Volumetric Flow Rate: 1.5 m³/min
Nano Stabilizer: Nano-illite
Curing Time: 28 days
Mix Ratio (Water-to-Nano Additives):5:1

The results of all of the nano examples of the stabilized and cured soil were unexpectedly better than expected. The soil strength has increased from 0.5 MPa to 14.5 MPa, the hydraulic conductivity has been reduced from 1.2×10\hat{ }−5 m/s to 3.4×10\hat{ }−7 m/s, and the compressibility of the soil has been enhanced from 0.45 to 0.12.

In Step E the prepared amounts of the first mixture, is typically mixed in situ (in place) with the soil by using a mixer 7 in order to obtain the second mixture. In one embodiment the mixing occurs directly in the ground, in another embodiment the mixing occurs before pumping the second mixture into the hole or drilled opening in the ground, in order to obtain an enhanced slurry, which is then pumped in the outer rod 1 and into the construction site, which is the drilled hole. In Step F a test is performed on the obtained second mixture. If the properties of the second mixture are as required, the next Steps H-N are performed, if not, Steps G and F are performed again.

The test is performed as follows:

If the test results show that it is necessary to add any ingredients to the obtained first mixture, in Step G the required amounts of the soil and/or the cement and/or the nano-additives and/or pico-additives are added to the first mixture and the obtained second mixture is mixed again in the mixer 7 in order to obtain the required properties of the third mixture. In one embodiment the mixer and the pump are combined together and they are indicated by the reference sign 7, in other embodiments those devices can be separated. In Step H a deep drilling is performed by the outer rod 1, equipped with the mixing head 3 and mixing blade 2, in the predetermined place or places on the construction site. In Step I the enhanced slurry is delivered or applied or pumped into the drilled soil in the predetermined place or places on the construction site using a device for supplying the enhanced slurry into the drilled soil, which in this embodiment is a pump 7.

In one embodiment of this invention, the volumetric flow rate for applying or injecting the enhanced slurry into the soil is 0.5 m³/min.

In another embodiment of this invention, the volumetric flow rate for applying or injecting the enhanced slurry into the soil is 1.0 m³/min.

In another embodiment of this invention, the volumetric flow rate for applying or injecting the enhanced slurry into the soil is 1.5 m³/min.

These values are typical for the enhanced slurry injection processes, but the exact rates can vary depending on the specific soil conditions and the composition of the enhanced slurry.

In Step J the soil is mixed with the enhanced slurry by using a deep soil mixing machine, or in this embodiment also by the outer rod 1, equipped with the mixing head 3 and mixing blade 2. In Step K, a nano stabilizer is injected to the soil mixed with the enhanced slurry.

In one embodiment of this invention, the nano stabilizer is nano-cement. In another embodiment of this invention, the nano stabilizer is nano-fly ash. In another embodiment of this invention, the nano stabilizer is nano-illite. In another embodiment of this invention, the nano stabilizer is nano-bentonite. These nano stabilizers are known for their effectiveness in improving soil properties, such as strength and durability.

In Step L the third mixture and nano stabilizer are mixed by the outer rod 1, equipped with the mixing head 3 and mixing blade 2, in the drilled soil or drilled hole or cavity in order to obtain a forth mixture.

In Step M the forth mixture is cured in order to obtain the enhanced soil. In one embodiment of this invention, the enhanced soil was cured for 7-92 days. In another embodiment of this invention, the enhanced soil was cured for 7-92 days. These ratios are typical for achieving optimal stabilization and performance in soil treatment.

In Step N the amount of moisture in the enhanced soil is continuously controlled and if necessary the amount of moisture is adjusted by adding required amount of water in order to obtain the desired performance criteria of the enhanced soil. In one embodiment of this invention, the mix ratio of water to the nano-additives was 3:1.

In another embodiment of this invention, the mix ratio of water to the nano-additives was 4:1.

In another embodiment of this invention, the mix ratio of water to the nano-additives was 5:1.

These ratios are typical for achieving optimal stabilization and performance in soil treatment.

### Technical Applicability

The method according the invention can be used for various types of geotechnical applications. Using nano-scale additives can reduce column diameters and decrease the amount of various additives such as cement or lime. This method promotes green technology and sustainability, offering a more environmentally friendly alternative to existing technologies that use macro and micro-sized additives.

### Definitions

$$First mixture = nano - additives and / or pico - additives + cement + water$$

$$Second mixture = first mixture + soil$$

$$Enhanced second mixture = second mixture + soil and / or + nano - additives and / or + pico - additives and / or + cement and / or + water$$

$$Enhanced slurry = second mixture or enhanced second mixture$$

$$Third mixture = enhanced slurry + soil$$

$$Fourth mixture = third mixture + nano stabilizer$$

$$Enhanced soil = cured forth mixture$$

Reference list:

1 - Outer rod
2 - Mixing blade
3 - Mixing head
4 - Drilling and mixing soil with cement grout
5 - Loose stratum
6 - Hard stratum
7 - Mixer and pump
8 - Drilling machine
9 - Powder or solution tank
10 - Cement storage tank
11 - Nano powder or nano solution
12 - Cement
13 - Stabilized mixture with various nano-additives
14 - Injector
15 - Mixing blade
16 - Earth

1. A method for enhancing soil properties in order to obtain an enhanced soil using a first mixture comprising cement, nano-additives and/or pico-additives and water in deep soil mixing, comprising the following steps:
Step A—obtaining a soil sample from a construction site,
Step B—identifying and testing physical and mechanical properties of the soil sample,
Step C—determining required amount and recommended mixing composition of the first mixture with the soil by using predetermined tests data and/or test results from Step F,
Step D—preparing and mixing the required amount of the nano-additives such cement, clay types, etc., and/or pico-additives, and water in order to obtain the first mixture,
Step E—mixing the prepared amount of the first mixture with the soil by using a mixer in order to obtain a second mixture,
Step F—performing the test on the obtained second mixture and if the properties of the second mixture are as required, performing the Steps H-N, if not, performing Steps G and F again,
Step G—cancelling the results of the previous Steps D and E, and going back to Step C again,
Step H—deep drilling in the predetermined places on the construction site,
Step I—applying or pumping the second mixture or the enhanced second mixture, wherein the second mixture or the enhanced second mixture is an enhanced slurry, into the drilled soil in the predetermined places on the construction site using a device for supplying the enhanced slurry into the drilled soil,
Step J—mixing the soil with the enhanced slurry by using a deep soil mixing machine in order to obtain a third mixture,
Step K—injecting nano stabilizer to the third mixture, and
Step L—mixing the third mixture with the nano stabilizer in the drilled soil in order to obtain a forth mixture,
Step M—curing the forth mixture in order to obtain the enhanced soil,
Step N—continuously controlling amount of moisture in the enhanced soil and if necessary adjusting the amount of moisture by adding required amount of water in order to obtain the desired performance criteria of the enhanced soil.

2. The method according to claim 1, wherein the nano-additives or the pico-additives are selected from the group including nano-fly ash, nano-rice husk, nano-cement, nano-bentonite, nano-clay, nano-illite, and nano-kaolinite.

3. The method according to claim 1, wherein the nano-additives or the pico-additives are ground to nano or pico sizes using a ball mill.

4. The method according to claim 1, wherein the optimal mix ratio of water-to-the nano-additives or the pico-additives ranges from 1:4 to 4:1 wt./wt.

5. The method according to claim 1, wherein volumetric flow rate for applying or injecting the enhanced slurry into the soil ranges from 0.08 to 1 m³/min, preferably from 0.1 to 0.8 m³/min, more preferably from 0.2 to 0.6 m³/min, most preferably from 0.4 to 0.5 m³/min.

6. The method according to claim 1, further comprising the step of compacting the enhanced soil by using a compaction equipment to enhance density and strength of the enhanced soil.
